(19) United States
(12) Patent Application Publication
(10) Pub. No.: US 2019/0045258 A1
(43) Pub. Date: Feb. 7, 2019

(54) SYSTEM AND METHOD FOR EVENT DATA COLLECTION AND ANALYSIS

(71) Applicant: Skoresheet, Inc., Temecula, CA (US)

(72) Inventors: Peter Karl Egedi, Fillmore, CA (US); Bernard Douglas Guenther, III, Saint Cloud, FL (US)

(73) Assignee: Skoresheet, Inc, Temecula, CA (US)

(21) Appl. No.: 16/052,148

(22) Filed: Aug. 1, 2018

Related U.S. Application Data
(60) Provisional application No. 62/539,957, filed on Aug. 1, 2017.

(51) Int. Cl. H04N 21/43; A63B 71/06; G06K 9/00; H04N 21/44; G01S 13/50

(52) U.S. Cl. CPC H04N 21/4302; A63B 71/0669; G01S 13/50; H04N 21/44016; G06K 9/00724

(57) ABSTRACT

Embodiments of the present systems and methods may provide the capability for entry, analysis, and distribution of scoring, statistical, and analysis data for events being transmitted over the Internet. For example, in an embodiment, a computer-implemented method for annotating a video stream may comprise receiving a video stream of a physical event, receiving data relating to the event, the data comprising an indication of an action occurring during the event and information describing the action, annotating the video stream with the information based on the received data relating to the event, wherein the annotation of the video stream is synchronized with occurrence of the event in the video stream, and transmitting the annotated video stream.

### CROSS-REFERENCE TO RELATED APPLICATIONS

This application claims the benefit of U.S. Provisional Application No. 62/539,957, filed Aug. 1, 2017, the contents of which are incorporated herein in their entirety.

### BACKGROUND

The present invention relates to techniques for real-time collection and analysis of event data.

Spectating at live events, such as sporting events, has long been a popular pastime. With the advent of video technologies, watching live or recorded events remotely has also been popular. The audience for watching major league games is sufficient to support television broadcasting of such events. However, there are large numbers of less widely significant events, such as school and local games, that do not warrant television broadcast, yet still would have a significant audience. The emergence of the Internet and video transmission over the Internet has made it possible for such less widely significant events to be transmitted to viewers. Whereas with television broadcasts, the league and the broadcaster may provide scoring, statistical, and analysis services, such services may not be available for local events transmitted over the Internet.

Accordingly, a need arises for techniques that may provide the capability for entry, analysis, and distribution of scoring, statistical, and analysis data for events being transmitted over the Internet.

### SUMMARY

Embodiments of the present systems and methods may provide the capability for entry, analysis, and distribution of scoring, statistical, and analysis data for events being transmitted over the Internet.

For example, in an embodiment, a computer-implemented method for annotating a video stream may comprise receiving a video stream of a physical event, receiving data relating to the event, the data comprising an indication of an action occurring during the event and information describing the action, annotating the video stream with the information based on the received data relating to the event, wherein the annotation of the video stream is synchronized with occurrence of the event in the video stream, and transmitting the annotated video stream.

In embodiments, the video stream may be a live stream of the physical event. At least a portion of the data relating to the event may be received from physical action sensors. The physical action sensors include at least one of an image recognition system and a radar speed sensor. The physical event may be a sporting event and the action is a play in the sporting event. An observer of the sporting event may enter a portion of the data relating to the sporting event. The method may further comprise storing information relating to participants in the sporting event, including at least one of league, team, and player information, generating statistical information relating to the participants in the sporting event in real-time based on the received data relating to the event, and annotating the video stream with the generated statistical information.

In an embodiment, a system for annotating a video stream may comprise a processor, memory accessible by the processor, and computer program instructions stored in the memory and executable by the processor to perform receiving a video stream of a physical event, receiving data relating to the event, the data comprising an indication of an action occurring during the event and information describing the action, annotating the video stream with the information based on the received data relating to the event, wherein the annotation of the video stream is synchronized with occurrence of the event in the video stream, and transmitting the annotated video stream.

In an embodiment, a computer program product for annotating a video stream may comprise a non-transitory computer readable storage having program instructions embodied therewith, the program instructions executable by a computer, to cause the computer to perform a method comprising receiving a video stream of a physical event, receiving data relating to the event, the data comprising an indication of an action occurring during the event and information describing the action, annotating the video stream with the information based on the received data relating to the event, wherein the annotation of the video stream is synchronized with occurrence of the event in the video stream, and transmitting the annotated video stream.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 illustrates an exemplary system 100 in accordance with embodiments of the present systems and methods.

FIG. 2 is an exemplary block diagram of an embodiment of a processing engine according to embodiments of the present systems and methods.

FIG. 3 is an exemplary block diagram of an embodiment of a mobile device and/or a computer system according to embodiments of the present systems and methods.

FIG. 4 is an exemplary illustration of a scoring app according to embodiments of the present systems and methods.

FIG. 5 is an exemplary illustration of a scoring app according to embodiments of the present systems and methods.

FIG. 6 is an exemplary illustration of a roster functionality according to embodiments of the present systems and methods.

FIG. 7 is an exemplary block diagram of embodiments of a Video Content Management System according to embodiments of the present systems and methods.

FIG. 8 is an exemplary illustration of live streaming according to embodiments of the present systems and methods.

FIG. 9 is an exemplary illustration of video-on-demand according to embodiments of the present systems and methods.

FIG. 10 is an exemplary block diagram of a computer system in which processes involved in the embodiments described herein may be implemented.

FIG. 11 is an exemplary illustration of league leaderboard functionality according to embodiments of the present systems and methods.

FIG. 12 is an exemplary illustration of league schedule functionality according to embodiments of the present systems and methods.

FIG. 13 is an exemplary illustration of participant profile functionality according to embodiments of the present systems and methods.

FIG. 14 is an exemplary illustration of participant statistics functionality according to embodiments of the present systems and methods.

FIG. 15 is an exemplary illustration of streaming schedule display and selection functionality according to embodiments of the present systems and methods.

FIG. 16 is an exemplary illustration of live streaming according to embodiments of the present systems and methods.

### DETAILED DESCRIPTION

Embodiments of the present systems and methods may provide the capability for entry, analysis, and distribution of scoring, statistical, and analysis data for events being transmitted over the Internet.

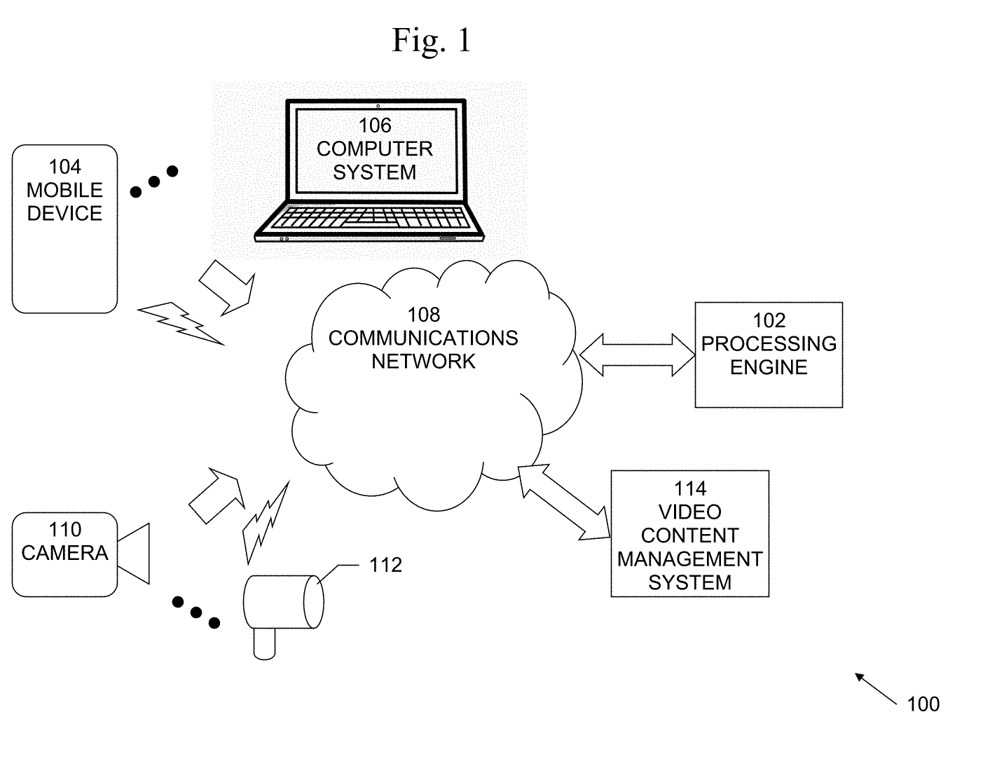

Embodiments of the present systems and methods may provide the capability for gathering and analyzing data relating to live, recorded, or past events, such as sporting events. An exemplary system 100 in accordance with such embodiments is shown in FIG. 1. In this example, system 100 may include a processing engine 102, a plurality of user devices, such as mobile devices 104 and computer systems 106, one or more communications networks 108, and action or event capture devices, such as camera 110 and radar gun 112. Processing engine 102 may include hardware and software to implement core database and business logic layers according to embodiments of the present systems and methods. Mobile devices 104 may include devices such as smartphone, tablets, personal digital assistants, etc., which may provide interface, computing, and communications capabilities that may be used to implement data entry, display, and administrative functions according to embodiments of the present systems and methods. Likewise, computer systems 106 may include devices such as personal computers, laptop computers, workstations, etc., which may provide interface, computing, and communications capabilities that may be used to implement data entry, display, and administrative functions according to embodiments of the present systems and methods.

In embodiments, communications network 108 may include any wired or wireless, public or private, standard or proprietary data communication networks. For example, communications network 108 may include local area networks, wide area networks, wireless networks, telecommunications carrier networks, the Internet, etc.

In embodiments, users, using mobile devices 104 and computer systems 106, may run apps that provide the capability to enter event-specific data, such as sport game, play, action, etc., information. Such entered event-specific data may be communicated, using communications network 108 to processing engine 102. Processing engine 102 may receive and process the event-specific data using general and event-specific processing rules, and store the results of such processing. Further, users may use the apps to obtain general or specific information relating to the events from processing engine 102. For example, users may obtain information relating to specific tournaments, games, matches, plays, actions, etc., as well as statistical information generated from the received and processed event-specific data.

In embodiments, action or event capture devices may include device such as camera 110 and radar gun 112. In embodiments, camera 110 may include one or more cameras being used to broadcast or stream the event to viewers, such as using Video Content Management System 114. In embodiments, camera 110 may include one or more special-purpose cameras directed to specific actions of the event. For example, for a baseball game, several cameras may be used for broadcasting the game to viewers, while one or more special-purpose cameras may be directed at the pitcher, the catcher, the batter, the strike zone, etc. Likewise, radar gun 112 may be used to obtain particular data, such as the speed of a pitch, etc. Further, although cameras and radar guns are used as examples, any other sensors or types of sensors may be used as well. Such cameras and other sensors may be used to supply data for automatic event recognition, which may supply data to processing engine 102. For example, cameras and radar guns may be used to capture information relating to a pitch in baseball, such as the speed of the pitch, the location of the pitch in the strike zone, etc., and may transmit that data to processing system 102 for storage and processing.

It is to be noted that, in FIG. 1, examples of particular devices and communicative connections are shown. These devices and communicative connections are merely examples. Rather and types and arrangements of devices and communicative connections may be utilized.

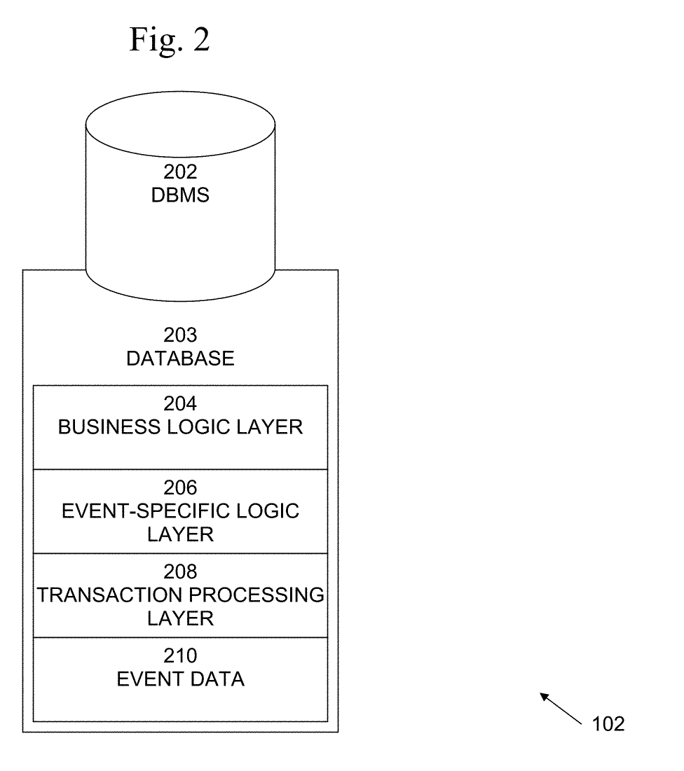

An exemplary block diagram of an embodiment of a processing engine 102 is shown in FIG. 2. In embodiments, processing engine 102 may include DataBase Management System (DBMS) 202, which may include database 203. Database 203 may include business logic layer 204, event-specific logic layer 206, transaction processing layer 208, and event data 210. DBMS 202 may include computer hardware and computer-software applications that interact with end-users, other applications, and database 203 to capture, store, and analyze data. For example, data relating to events, such as score and play information from sports games, may be stored and processed in DBMS 202. In particular, DBMS 202 may receive and process event-specific data using business logic layer 204 and event-specific logic layer 206 rules, and may store unprocessed event data, as well as the results of the processing as event data 210.

DBMS 202 may, for example, be hosted in the cloud, in a specific Web service, on dedicated or proprietary servers, etc. Business logic layer 204 may include processing, computation, logical rule evaluation, etc. to support events, such as sports games. Event-specific logic layer 206 may include processing, computation, logical rule evaluation, etc., to support specific events, such as specific sports, specific games, matches, tournaments, etc., and specific rules requirements of each sport.

Database 203 may include a unique set of event data 210 tables to track each game, play, action, etc. For example, for baseball, event data 210 tables may be set up to track each pitch rather than the traditional play by play configuration. The pitch table may allow users to break down a game on a micro level by evaluating relationships between pitchers and batters. In embodiments, database 203 may be implemented so that it will auto-scale based on the performance of the servers while still providing real time data to the front-end viewers.

Users may use the apps to communicate with transaction processing layer 208 to obtain general or specific information relating to the events from DBMS 202. For example, users may obtain information relating to specific tournaments, games, matches, plays, actions, etc., as well as statistical information generated from the received and processed event-specific data 210. Further, fast transaction processing, provided by transaction processing layer 208, may allow real-time data to be sent to the viewers without delays.

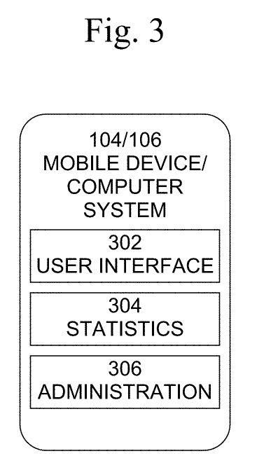

An exemplary block diagram of an embodiment of a mobile device 104 and/or a computer system 106 is shown in FIG. 3. In embodiments, mobile device 104/computer system 106 may include one or more of user interface module 302, statistics module 304, and administration module 306. User interface module 302 may include software and hardware for entering, acquiring, and receiving data relating to the occurrence of events, as well as for streaming of live or recorded events, enhanced with additional event data. For example, user interface module 302 may include functionality for scoring games or matches that has been designed or customized specifically for each sport. User interface module 302 may support specific rule sets established by governing bodies of the sport. User interface module 302 may be agnostic to a specific device and operating system. For example, user interface module 302 may be run on Android, iOS, or Microsoft operating systems.

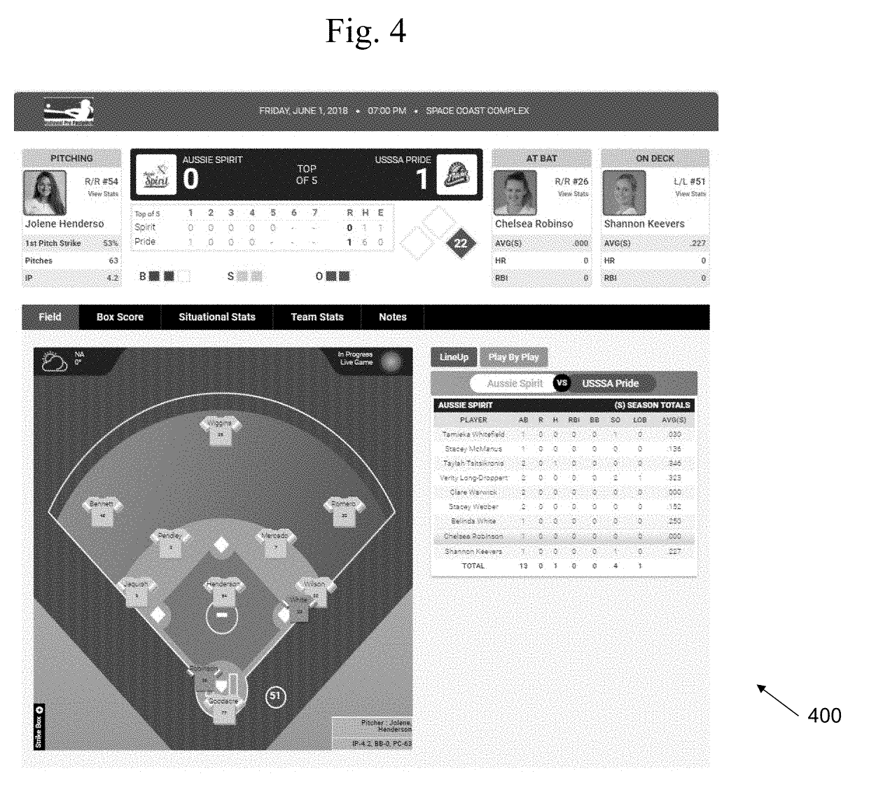

An exemplary illustration of a scoring app 400 that may be provided by user interface module 302 is shown in FIG. 4. In this example, scoring app 400 has been configured to score baseball. The intuitive nature of scoring screen 400 is unique and allows for the users of any level to use the same application for games in at a variety of age levels, as well as for amateur and professional games. Users can choose a specific rule set and make adjustments according to their needs if the rule set needs to be changed.

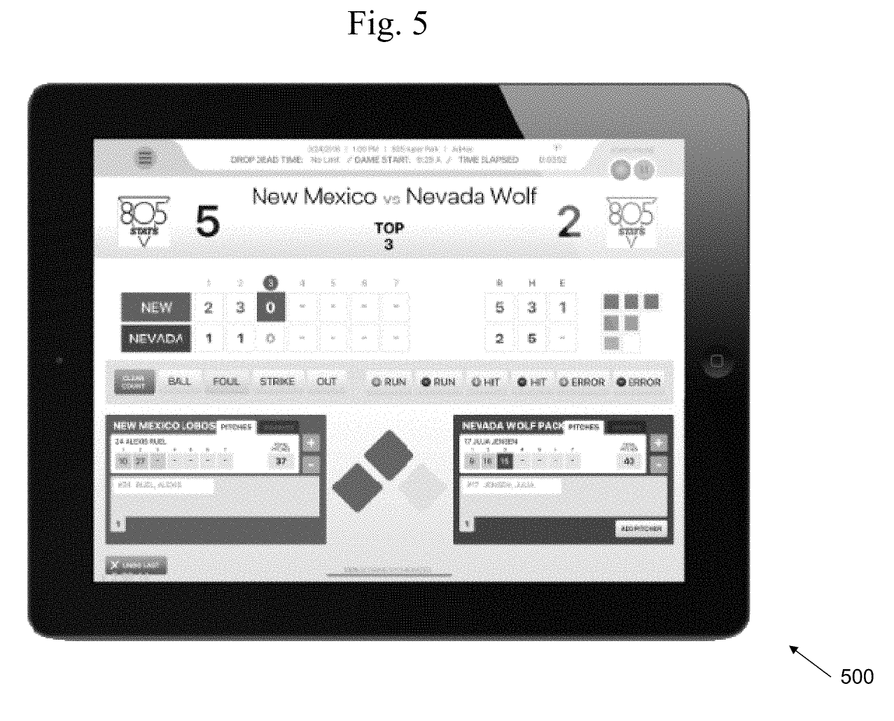

An exemplary illustration of a Basic version of a scoring app 500 that may be provided by user interface module 302 is shown in FIG. 5. In this example, scoring app 500 has been configured to score baseball. Scoring app 500 may provide for easy scoring but may not utilize players except for pitchers. The batters may not be tracked for statistical purposes, but scoring app 500 may maintain the linescore and pitch information to advance brackets and standings. Scoring app 500 (the basic version) may also sends the entered, acquired, or received data autonomously to the livestreaming platform to populate score widgets in the video.

Game lists may populated from the administration module 306 (discussed below) in real time and may provide the capability for the users to score the game without creating it in the app. Further, games may be imported by the use of an API, which doesn't require human interaction to get games in to the system

In embodiments, user interface module 302 may detect network connectivity and may allow the user to score the game without connectivity. Once the connection is re-established, user interface module 302 may sync the data with processing engine 102, shown in FIG. 1. Such offline scoring lets the user continue scoring the game even when network connectivity is lost.

In embodiments, user interface module 302 may transmit information about the entered data. For example, user interface module 302 may generate in real-time game data in, for example, XML, format, which may be transmitted using network protocols, such as FTP, to populate various displays and also to provide data for front end viewing. Such real-time game data may be formatted in standard league or organization approved formats. For example, user interface module 302 may communicate with scoreboard hardware to add the game information to the scoreboards in real time, there is no need to have a scoreboard operator.

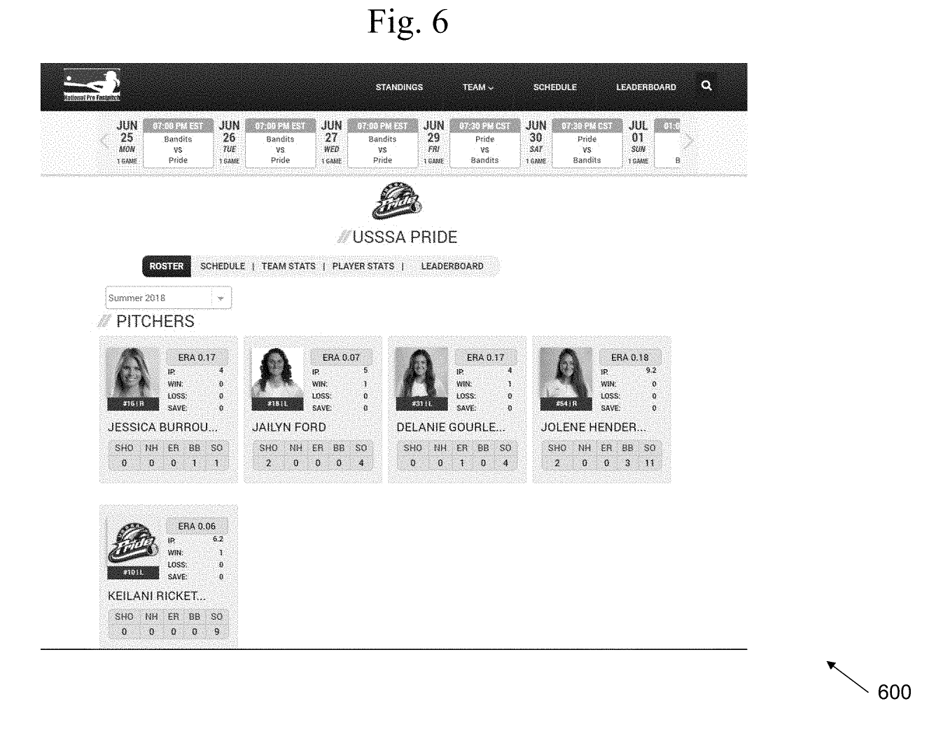

An exemplary illustration of a roster functionality 600 that may be provided by embodiments of user interface module 302 is shown in FIG. 6. Rosters may imported in to the application from, for example, event data 210 of processing system 102 and may be maintained in real time.

In embodiments, user interface module 302 may provide the capability for users to watch the game they are scoring using livestreaming, or to watch other games from within user interface module 302 rather than exiting and watching the games from the web or external applications. Further, user interface module 302 may provide reports on weather and injury delays to keep the viewers engaged during games. Such alerts may be displayed on the front end screens in real time.

User interface module 302 may provide the capability for emailing of reports, which may save users time and energy by having the reports available in the application. As user interface module 302 may be device agnostic, users may utilize any device and may not be required to purchase and maintain only certain devices or certain types of devices.

Postponing games is easy and will let the users add a new date in the app if the game is rescheduled.

In embodiments, user interface module 302 may provide the capability for manual or automated data entry. Manual data entry has been discussed above. Automated data entry may utilize data received from automated game monitoring systems or devices, For example, FLIGHTSCOPE® is an automated ball detection system that uses 3D Doppler radar (such as 112 in FIG. 1) to determine the speed, trajectory, and location of balls for a variety of sports, such as golf, baseball, etc. For example, in baseball, FLIGHTSCOPE® may provide about 25 points of data about the pitches and hits for each play and pitch. User interface module 302 may receive such ball-related information, process such information, and automatically enter the data in the appropriate locations. For example, in baseball, pitch locations may be automatically entered using data received from FLIGHTSCOPE®. User interface module 302 may receive, process, and enter information from other systems, for example POCKET RADAR® (such as 112 in FIG. 1), etc.

In embodiments, administration module 306 may provide the capability to configure and administer screen, rules, data, etc. For example, administration module 306 may provide an app-based or Web-enabled administrative interface providing league, team and player management, which may include establishing a subscription to manage an entire league of teams, or just one team. Administrators may be provided with a platform to manage team rosters, game lineups, team communications, team profile settings, etc.

Backend administrative functionality, which may be implemented, for example, using processing engine 102, shown in FIG. 1, may take into account the needs of users as to whether they are a league with multiple teams they control or teams they do not control. This allows different types of configurations to be accounted for and provides the proper front end format to display the statistics properly.

In embodiments, full season data for each type may be supplied automatically and may not need an account manager to setup a user. In embodiments, for ease of use there may be standard login interfaces, such as the FACEBOOK® and GOOGLE® login application program interfaces (APIs) implemented so the users have a seamless login process. In embodiments, the backend may also manage third party integrations when creating a game so there is no duplicate entry and the time to get the data entered into the system may be reduced.

In embodiments, when sensor systems, such as FLIGHTSCOPE® or POCKET RADAR® integrations are used, such functionality may be added quickly when creating a game and without additional setup. In embodiments, the type of user may be determined based on their selections at registration and the default app configurations for that user may be determined accordingly. In embodiments, a single dashboard may manage a league, team or organization which makes the process easier. This is advantageous to eliminate multiple accounts and keeps everything in a single sign on. In embodiments, artificial intelligence features may be used to eliminate duplicate players so all players are only in the system once, which eliminates broken accounts.

In embodiments, statistics module 304 may provide the capability for computing and displaying statistics based on the collected and processed event data. For example, statistics module 304 may provide an app or Web-enabled view of statistics collected during the course of scoring a game. Statistics may be broken down as desired, such as by league, team and player accumulative stats. Basic and Advanced statistical analysis may be provided with analytical reporting. In embodiments, a Web-based interface may be fully responsive for all devices and screen sizes. In embodiments, statistics module 304 may provide full comprehensive leaderboards for teams and players. In embodiments, each web page may be printable and downloadable for the viewers to capture the data on teams. In embodiments, Web pages may be made private so only users with a login can access them. In embodiments, selected event data, such as pitch locations, pitch speeds and full FLIGHTSCOPE® or POCKET RADAR® data may be displayed on the front end screens. In embodiments, delay types may be shown for viewers on the front end.

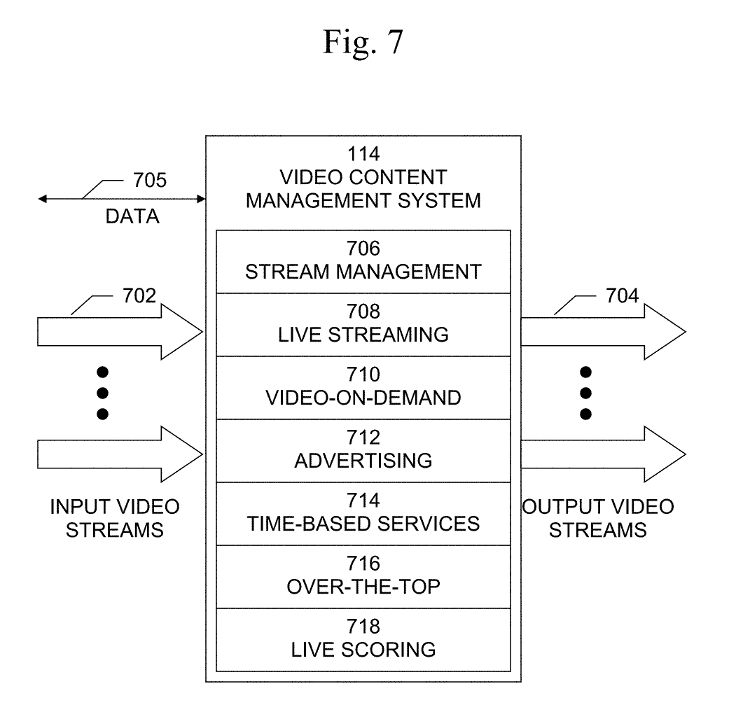

In embodiments, video broadcast/streaming may be provided by Video Content Management System 114. Video Content Management System 114 may include a number of technologies that provide the capability for broadcasting video of events live, delayed, after the fact, or on demand via web access, mobile application access, or Over-The-Top (OTT) content access. An exemplary block diagram of embodiments of a Video Content Management System 114 is shown in FIG. 7. In this example, Video Content Management System 114 may receive input video streams 702, may generate output video streams 704, and may receive and transmit data 705. Further, Video Content Management System 114 may include stream management module 706, live streaming module 708, video-on-demand module 710, advertising module 712, time-based services module 714, over-the-top module 716, and live scoring module 718.

In embodiments, stream management module may receive data 705 that will allow a user to assign video streams to events, add meta data tags, add them to categories and general management. Administration module 306 may send data to stream management module 706 to create streams associated with events. This allows the two to be linked and share database data, such as player in formation and stats. In embodiments, stream management module 706 may add on-screen score widgets to display scores and other data from the scoring program autonomously and store play data in the bookmarking process

This is a single sign on process which works with our scoring admin and can be accessed from the scoring dashboard

The system manages the video on demand and the hierarchy of the categories to make the front end as professional as possible

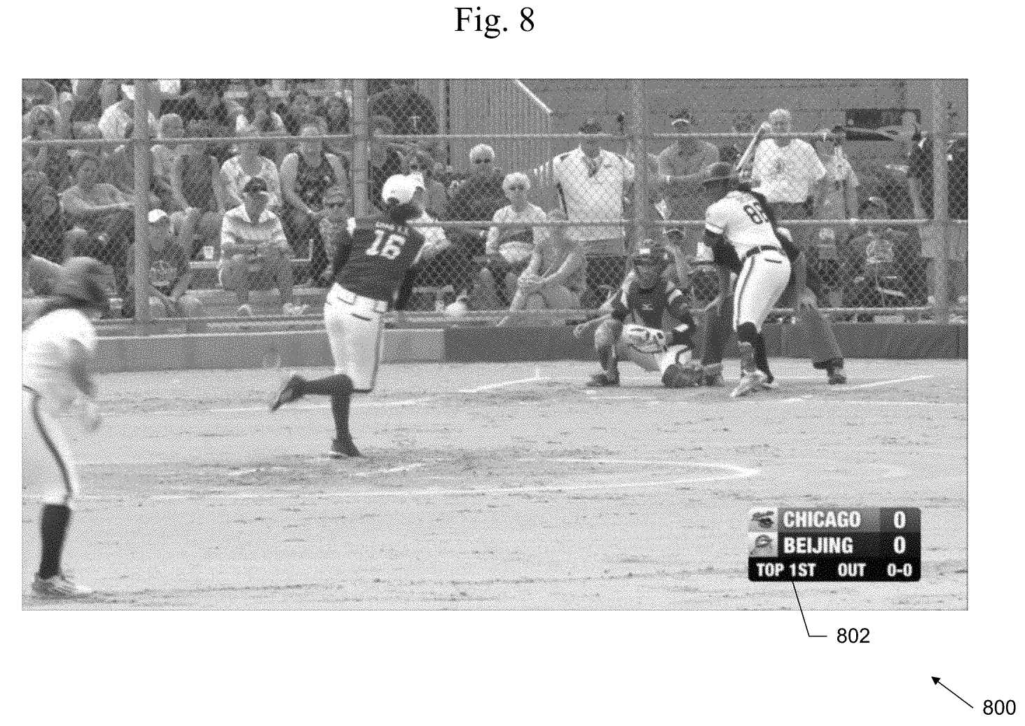

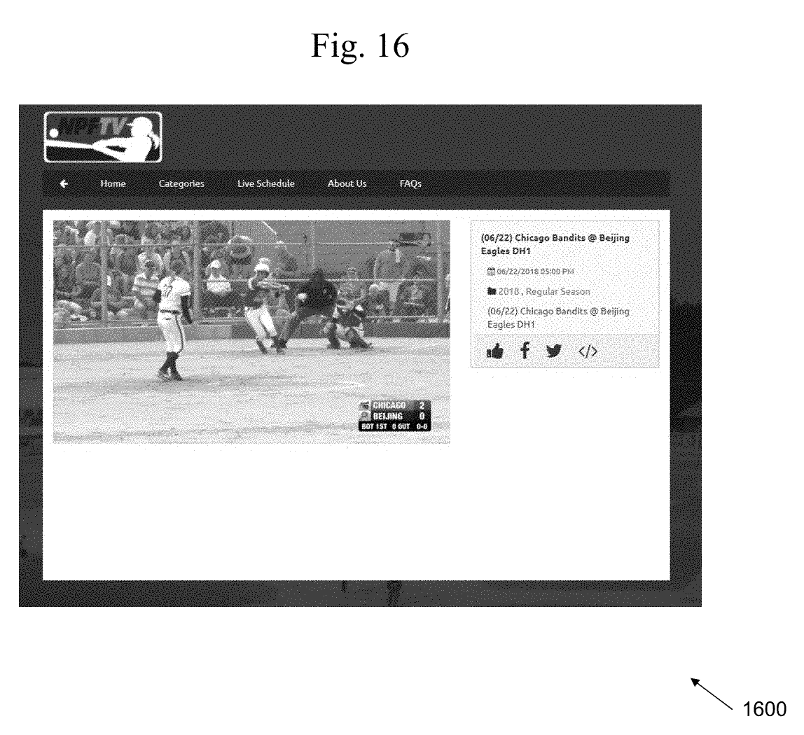

In embodiments, live streaming module 708 may provide the capability for live streaming of events that is synchronized with features of user interface module 302, shown in FIG. 3. An exemplary illustration of live streaming is shown in FIG. 8. For example, live streaming may be enhance with real-time event data 802, such as event status and statistics, which may be viewed within the framework of the streaming. Likewise, additional information, as shown in the example of FIG. 16, may be displayed. In embodiments, users may access a live game via the Web or using the app.

In embodiments, the streaming engine may be a standard streaming engine or it may be custom-designed. The streaming engine be hosted in the cloud, in a specific Web service, on dedicated or proprietary servers, etc. For example, the WOWZA® Streaming Engine software may be used. The transcoding may be set for improved efficiency and will allow users to upload video and have it playback in a plurality of different resolutions depending on the bandwidth of the user device. The streaming player may be designed to work with all devices including older operating systems and auto detects the version they are running.

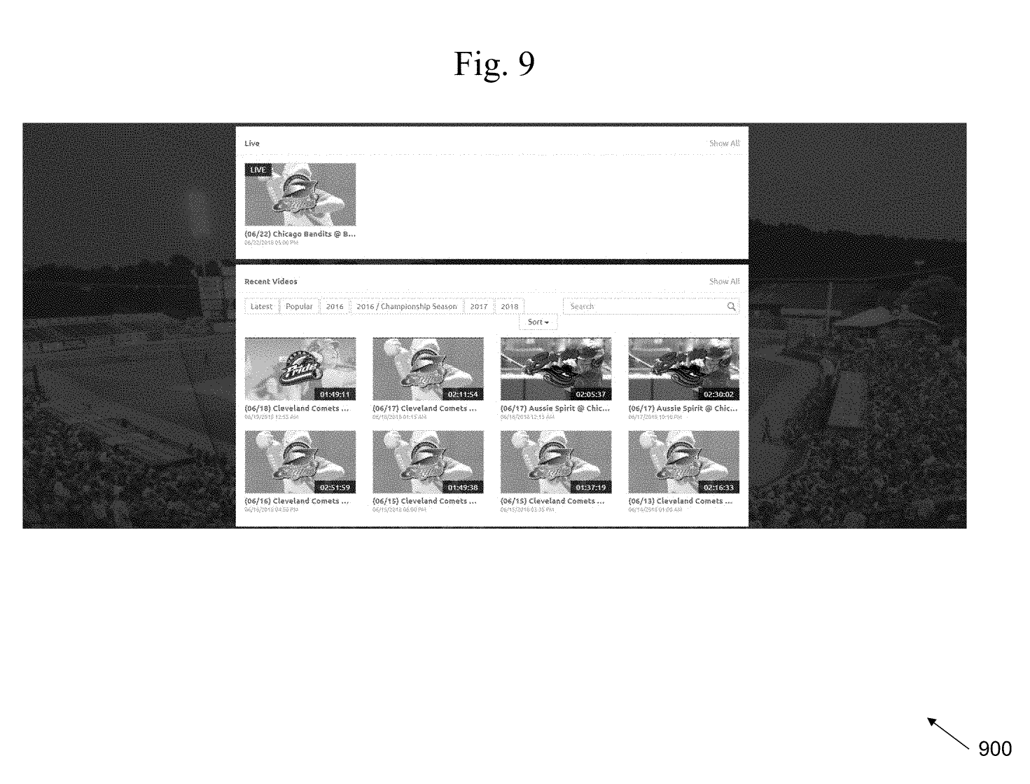

In embodiments, video-on-demand module 710 may provide the capability for on-demand access to archived videos after the initial live stream. As shown in the exemplary illustration of FIG. 9, video-on-demand programs may be listed in categories and may provide cross-category sections so the program can be accessed in multiple locations. In embodiments, there may be only one stored file for each program, which may be transcoded on the fly into a plurality of resolutions for easy playback.

In embodiments, advertising module 712 may provide advertising in live and on-demand videos. For example, advertising module 712 may provide pre-roll advertisements that run each time the stream is accessed Likewise, advertising module 712 may provide mid-roll advertising during a video. This may be achieved by having the scoring app of user interface module 302 synchronized with the streaming engine. The scoring app may notify the streaming engine when there is a break in the action of the event and may the running advertisements without the user needing to prompt the system. For example, the scoring app may provide advertisements there is a timeout in the event or in between innings. This increases the ability to gain revenues without additional production staff or any drag on the scorekeepers. Static ads may be placed on pages with volume to add additional revenues to the customer sites.

In embodiments, time-based services module 714 may provide time based services such as synchronization and timestamping. For example, the scoring app may be synchronized with the one or more video streams. Further, a timestamp may be added to the video with an action ID attached. Examples of action ID may include identifications of all or selected actions. For example, in baseball, pitches, throws, catches, etc., may be marked and timestamped. Likewise, in football, plays, passes, kicks, etc., may be marked and timestamped, while in basketball, shots, passes, etc., may be marked and timestamped. This allows users to scroll to a certain location of the video for each play they want to view. Additionally the highlighted actions may be associated with the players that were involved in the action and such association or correspondence information may be logged in the database, event data 210. For example, in the database, the players involved and information about the action may be logged automatically. In embodiments, the video is kept whole so there are not individual clips stored. Rather, in such embodiments, only timestamps may be recorded and added to the database for easy searching.

In embodiments, once the timestamp and action ID information has been stored, such information may be used to perform highlight clip extraction. For example, the timestamps in the video may be used during the event to provide an easy search for the user to extract clips of highlights after or during a game. In embodiments, all the plays may be connected using the timestamp and action ID information to provide the capability to search a specific set of actions. In embodiments, the clips can be sent to social media or emailed directly from the platform. In embodiments, the searching may be event agnostic and may display the actions in categories.

In embodiments, over-the-top (OTT) module 716 may provide over-the-top digital video, which, for example, may delivered over the Internet via OTT devices, such as ROKU®, AMAZON-FIRESTICK®, APPLE TV®, etc. In embodiments, OTT may be provided using financial models such as advertising, or ad based, video-on-demand (AVOD), which is typically free to the user and advertisement supported, and transactional video-on-demand (TVOD), which is transactional pay for individual pieces of content.

In embodiments, Live Scoring module 718 may provide “Live Scoring” views of events in real time, displaying information such as Player information, Box Score, Situational Stats, Team Stats, Notes and Play by Play.

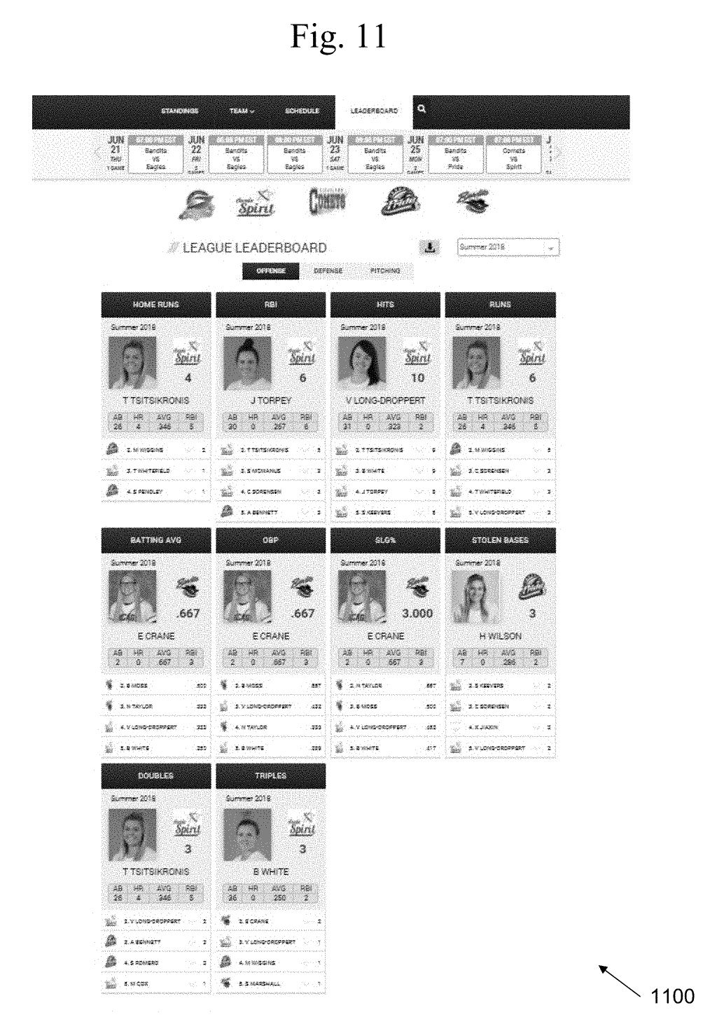

An example of a league leaderboard functionality 1100 that may be provided by embodiments of the present systems and methods is shown in FIG. 11. League leaderboard 1100 may be automatically generated by processing engine 102 from event data 210 and may be displayed automatically, or on demand using user interface module 302 and/or statistics module 304.

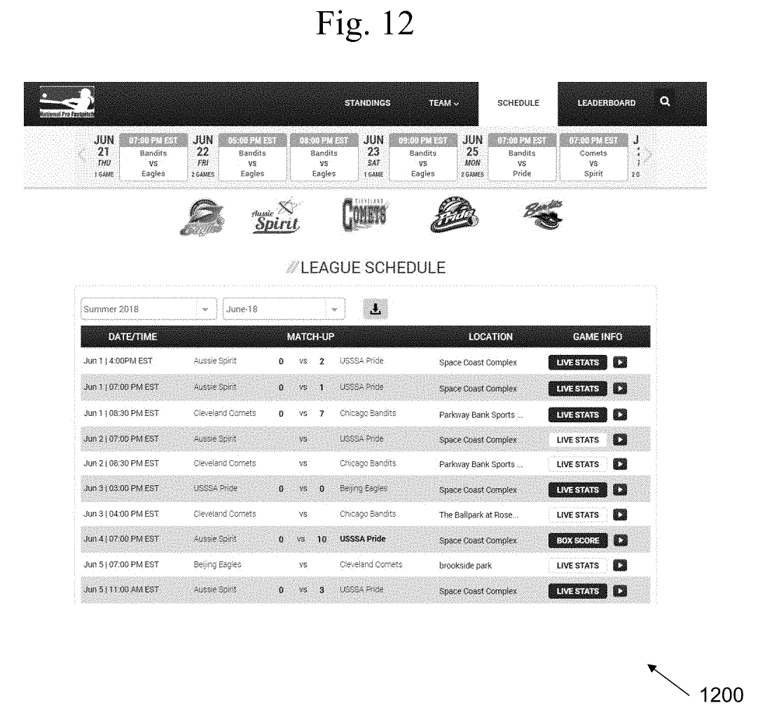

An example of a league schedule functionality 1200 that may be provided by embodiments of the present systems and methods is shown in FIG. 12. League schedule 1200 may be included in, accessed from, or access data received from administration module 306 and may provide the capability to schedule events for one or more teams or groups, up to and including an entire league of teams.

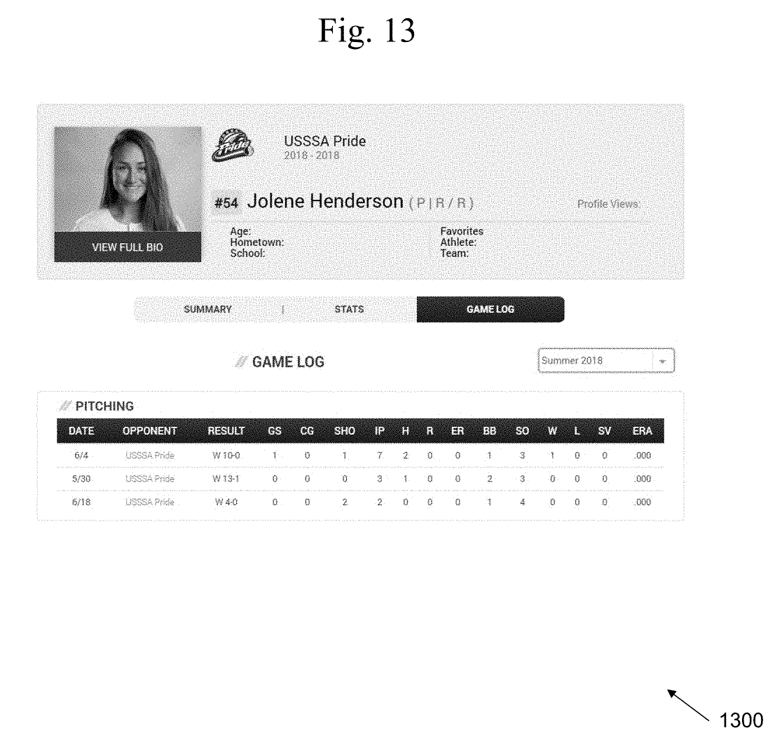

An example of a participant profile functionality 1300 that may be provided by embodiments of the present systems and methods is shown in FIG. 13. Participant profile 1300 may be configured from administration module 306 and/or a user interface module 302 of a player and may be viewed in user interface modules 302 of various users. Participant profile 1300 may provide the capability to enter information about individual participants in events, which may be entered by an administrator using administration module 306 or by or a participant using user interface module 302. Further, in embodiments, participant profile functionality 1300 may be viewed by all or selected users using user interface module 302.

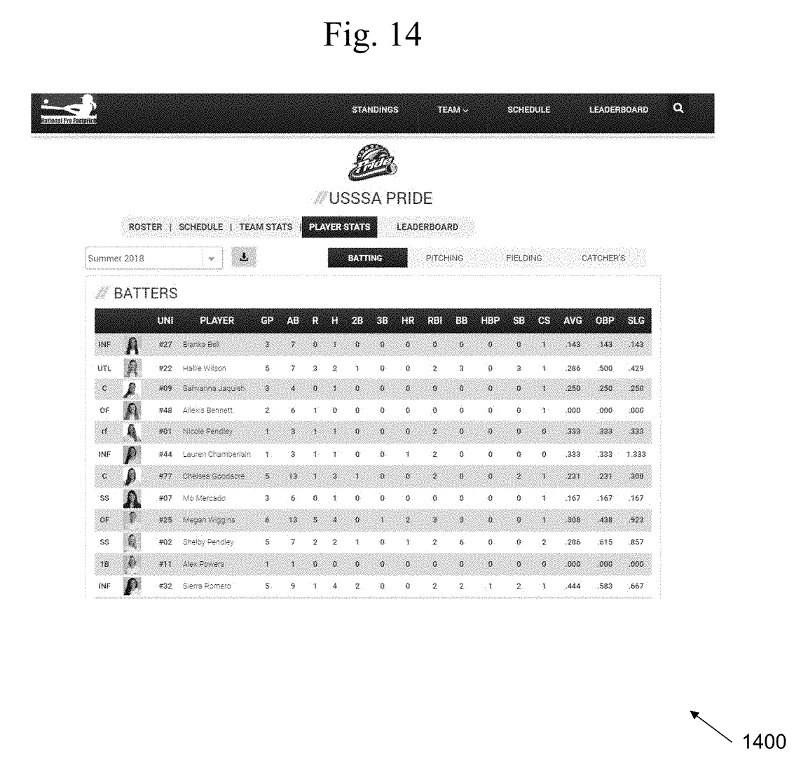

An example of a participant statistics functionality 1400 that may be provided by embodiments of the present systems and methods is shown in FIG. 14. Participant statistics 1400 may be automatically generated by processing engine 102 from event data 210 and may be displayed automatically, or on demand using user interface module 302 and/or statistics module 304.

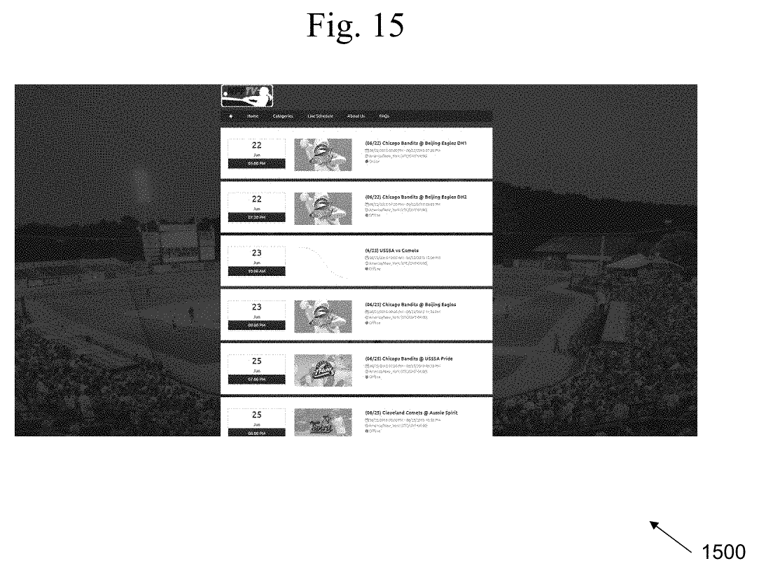

An example of a streaming schedule display and selection functionality 1500 is shown in FIG. 15. In this example, streaming schedule display and selection functionality 1500 may provide the capability to display current and upcoming live streaming events that are or may become available for viewing and may provide the capability for a user to select one or more such events for viewing. In embodiments, past recorded events may also be shown and the capability for on-demand viewing of such recorded events may also be provided.

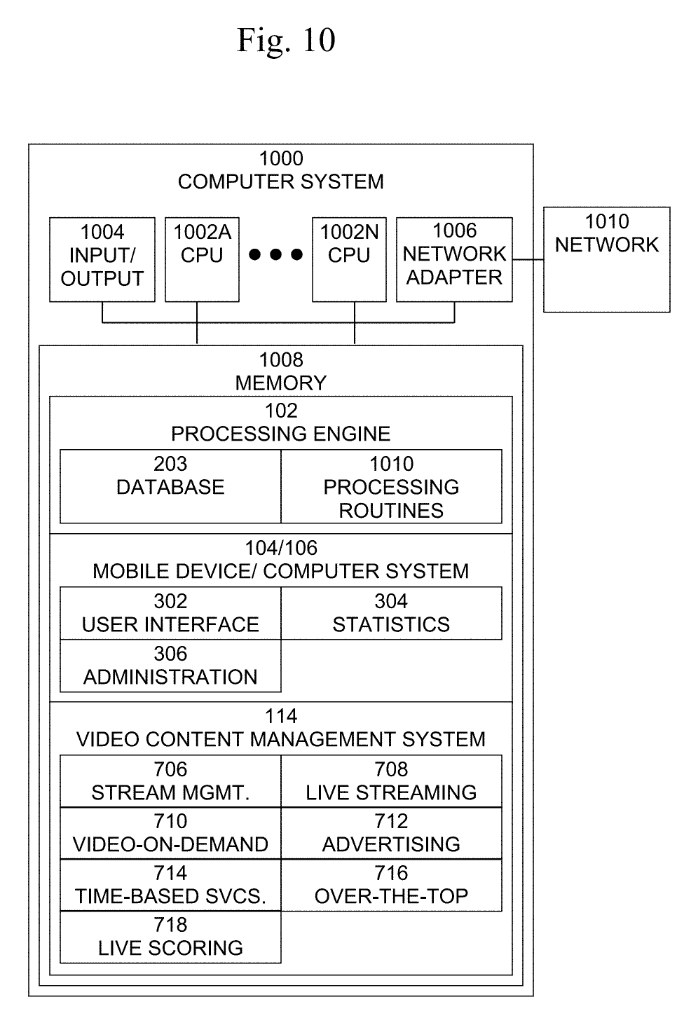

An exemplary block diagram of a computer system 1002, in which processes involved in the embodiments described herein may be implemented, is shown in FIG. 10. Computer system 1002 may be implemented using one or more programmed general-purpose computer systems, such as embedded processors, systems on a chip, personal computers, workstations, server systems, and minicomputers or mainframe computers, or in distributed, networked computing environments. Computer system 1002 may include one or more processors (CPUs) 1002A-1002N, input/output circuitry 1004, network adapter 1006, and memory 1008. CPUs 1002A-1002N execute program instructions in order to carry out the functions of the present communications systems and methods. Typically, CPUs 1002A-1002N are one or more microprocessors, such as an INTEL CORE® processor. FIG. 10 illustrates an embodiment in which computer system 1002 is implemented as a single multi-processor computer system, in which multiple processors 1002A-1002N share system resources, such as memory 1008, input/output circuitry 1004, and network adapter 1006. However, the present communications systems and methods also include embodiments in which computer system 1002 is implemented as a plurality of networked computer systems, which may be single-processor computer systems, multi-processor computer systems, or a mix thereof.

Input/output circuitry 1004 provides the capability to input data to, or output data from, computer system 1002. For example, input/output circuitry may include input devices, such as keyboards, mice, touchpads, trackballs, scanners, analog to digital converters, etc., output devices, such as video adapters, monitors, printers, etc., and input/output devices, such as, modems, etc. Network adapter 1006 interfaces device 1000 with a network 1010. Network 1010 may be any public or proprietary LAN or WAN, including, but not limited to the Internet.

Memory 1008 stores program instructions that are executed by, and data that are used and processed by, CPU 1002 to perform the functions of computer system 1002. Memory 1008 may include, for example, electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra-direct memory access (UDMA), or a small computer system interface (SCSI) based interface, or a variation or enhancement thereof, such as fast-SCSI, wide-SCSI, fast and wide-SCSI, etc., or Serial Advanced Technology Attachment (SATA), or a variation or enhancement thereof, or a fiber channel-arbitrated loop (FC-AL) interface.

The contents of memory 1008 may vary depending upon the function that computer system 1002 is programmed to perform. In the example shown in FIG. 10, exemplary memory contents are shown representing routines and data for embodiments of the processes described above. However, one of skill in the art would recognize that these routines, along with the memory contents related to those routines, may not be included on one system or device, but rather may be distributed among a plurality of systems or devices, based on well-known engineering considerations. The present communications systems and methods may include any and all such arrangements.

In example shown in FIG. 10, memory contents are shown for processing engine 102, mobile device/computer system 104/106, and video content management system 114. It is to be noted that this is merely an example. In many embodiments, each of processing engine 102, mobile device/computer system 104/106, and video content management system 114 may be implemented in separate computer systems.

In the example shown in FIG. 10, memory contents for processing engine 102 may include database 203 and processing routines 1010, memory contents for mobile device/computer system 104/106 may include user interface module 302, statistics module 304, and administration module 306, and memory contents for video content management system 114 may include stream management module 706, live streaming module 708, video-on-demand module 710, advertising module 712, time-based services module 714, over-the-top module 716, and live scoring module 718. Database 203 may include software routines and data structures to capture, store, and analyze data. Processing routines 1010 may include software routines to process data to be stored and analyzed by database 203. User interface module 302 may include software routines for entering, acquiring, and receiving data relating to the occurrence of events, as well as for streaming of live or recorded events, enhanced with additional event data. Statistics module 304 may include software routines for computing and displaying statistics based on the collected and processed event data. Administration module 306 include software routines to configure and administer screen, rules, data, etc. Stream management module 706 may include software routines to assign video streams to events, add meta data tags, add them to categories and general management. Live streaming module 708 may include software routines for live streaming of events that is synchronized with features of user interface module 302. Video-on-demand module 710 may include software routines for on-demand access to archived videos after the initial live stream. Advertising module 712 may include software routines to provide advertising in live and on-demand videos. Time-based services module 714 may include software routines to provide time based services such as synchronization and timestamping. Over-the-top module 716 may include software routines to provide over-the-top digital video, which, for example, may delivered over the Internet via OTT devices. Live scoring module 718 may include software routines to provide “Live Scoring” views of events in real time. In all cases, an operating system (not shown) may provide overall system functionality.

As shown in FIG. 10, the present communications systems and methods may include implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including Linux, UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A computer-implemented method for annotating a video stream, the method comprising:
receiving a video stream of a physical event;
receiving data relating to the event, the data comprising an indication of an action occurring during the event and information describing the action;
annotating the video stream with the information based on the received data relating to the event, wherein the annotation of the video stream is synchronized with occurrence of the event in the video stream; and
transmitting the annotated video stream.

2. The method of claim 1, wherein the video stream is a live stream of the physical event.

3. The method of claim 2, wherein at least a portion of the data relating to the event is received from physical action sensors.

4. The method of claim 3, wherein the physical action sensors include at least one of an image recognition system and a radar speed sensor.

5. The method of claim 4, wherein the physical event is a sporting event and the action is a play in the sporting event.

6. The method of claim 5, wherein an observer of the sporting event enters a portion of the data relating to the sporting event.

7. The method of claim 6, further comprising:
storing information relating to participants in the sporting event, including at least one of league, team, and player information;
generating statistical information relating to the participants in the sporting event in real-time based on the received data relating to the event; and
annotating the video stream with the generated statistical information.

8. A system for annotating a video stream, the system comprising a processor, memory accessible by the processor, and computer program instructions stored in the memory and executable by the processor to perform:
receiving a video stream of a physical event;
receiving data relating to the event, the data comprising an indication of an action occurring during the event and information describing the action;
annotating the video stream with the information based on the received data relating to the event, wherein the annotation of the video stream is synchronized with occurrence of the event in the video stream; and
transmitting the annotated video stream.

9. The system of claim 8, wherein the video stream is a live stream of the physical event.

10. The system of claim 9, wherein at least a portion of the data relating to the event is received from physical action sensors.

11. The system of claim 10, wherein the physical action sensors include at least one of an image recognition system and a radar speed sensor.

12. The system of claim 11, wherein the physical event is a sporting event and the action is a play in the sporting event.

13. The system of claim 12, wherein an observer of the sporting event enters a portion of the data relating to the sporting event.

14. The system of claim 13, further comprising:
storing information relating to participants in the sporting event, including at least one of league, team, and player information; and
generating statistical information relating to the participants in the sporting event in real-time based on the received data relating to the event.

15. A computer program product for annotating a video stream, the computer program product comprising a non-transitory computer readable storage having program instructions embodied therewith, the program instructions executable by a computer, to cause the computer to perform a method comprising:
receiving a video stream of a physical event;
receiving data relating to the event, the data comprising an indication of an action occurring during the event and information describing the action;
annotating the video stream with the information based on the received data relating to the event, wherein the annotation of the video stream is synchronized with occurrence of the event in the video stream; and
transmitting the annotated video stream.

16. The computer program product of claim 15, wherein the video stream is a live stream of the physical event.

17. The computer program product of claim 16, wherein at least a portion of the data relating to the event is received from physical action sensors.

18. The computer program product of claim 17, wherein the physical action sensors include at least one of an image recognition system and a radar speed sensor.

19. The computer program product of claim 18, wherein the physical event is a sporting event and the action is a play in the sporting event.

20. The computer program product of claim 19, wherein an observer of the sporting event enters a portion of the data relating to the sporting event.

21. The computer program product of claim 20, further comprising:
storing information relating to participants in the sporting event, including at least one of league, team, and player information;
generating statistical information relating to the participants in the sporting event in real-time based on the received data relating to the event; and
annotating the video stream with the generated statistical information.
